(19) United States
(12) Patent Application Publication
(10) Pub. No.: US 2013/0312245 A1
(43) Pub. Date: Nov. 28, 2013

(54) METHOD FOR SETTING A BLIND RIVET, BLIND RIVET AND PULLING HEAD FOR RECEIVING OF A BLIND RIVET

(71) Applicant: Richard Bergner Verbindungstechnik GmbH & Co. KG, Schwabach (DE)

(72) Inventors: ANDREAS SKOLAUDE, SCHWABACH (DE); KLAUS DEHLKE, WINDSBACH (DE)

(73) Assignee: Richard Bergner Verbindungstechnik GmbH & Co. KG, Schwabach (DE)

(21) Appl. No.: 13/897,600

(22) Filed: May 20, 2013

(30) Foreign Application Priority Data
May 18, 2012 (DE) 10 2012 208 371.5

(51) Int. Cl. B21J 15/04; F16B 19/10; B21J 15/28

(52) U.S. Cl. CPC B21J 15/043; B21J 15/28; F16B 19/1045
USPC 29/525.06; 29/243.521; 411/80.5

(57) ABSTRACT

In order to ensure that the process of setting a blind rivet is reliable, during the setting operation a rivet mandrel is gripped by gripping jaws of a tension head and is pulled in the axial direction for deforming a rivet sleeve. The tension head and the rivet mandrel, in this case, are matched to one another in such a manner that the gripping jaws initially slide along a gripping portion along the rivet mandrel in their closed position until they reach a predetermined tension position, which is defined in particular by a stop, from which the necessary tensile force for the deforming of the rivet sleeve is first transferred onto the rivet mandrel.

The invention relates to a method for setting a blind rivet by means of a tension head having the features of the preamble of claim 1. The invention additionally relates to a blind rivet and to a tension head for such a method.

A method for this type can be found, for example, from DE 40 03 494 A1.

Blind rivets generally have a rivet sleeve which is penetrated by a rivet mandrel. At its one end, the rivet mandrel has a mandrel head, by way of which it deforms the rivet sleeve during the setting operation in order to realize a closing head. On the opposite end, the rivet mandrel has a gripping portion which, during the setting operation, is gripped by a tension head of a setting tool which exerts a tensile force during the setting operation in order to deform the rivet sleeve and in order to realize the setting head. The setting operation is concluded once a predetermined defined setting force has been reached. The rivet mandrel usually has a predetermined breaking point at which the rivet mandrel shears once the setting operation has been completed and once the predetermined setting force has been reached.

For gripping the rivet mandrel by the tension head, modern rivet mandrels have a groove structure with a plurality of grooves in the gripping portion. The tension head usually has gripping jaws which are displaced radially for clamping the rivet mandrel. The gripping jaws, in this case, usually also have a groove structure which is realized in a corresponding manner to the groove structure of the rivet mandrel and engages in said groove structure and, in this case, forms a multitude of positive locking means between the corresponding grooves or webs between the grooves.

Automated setting methods by means of blind rivet robots conclusively require a high degree of process reliability with a small amount of susceptibility to faults. A certain fault susceptibility has been shown in the case of the above-described gripping system with the corresponding groove structures. The cause in this case is a non-optimum alignment between the two gripping part systems of rivet mandrel and gripping jaws. Thus, for example, there is a risk of the ring-shaped webs on the rivet mandrel being sheared by the tensile force exerted if the webs of the gripping jaws do not engage in the grooves of the rivet mandrel but rather strike the webs of the rivet mandrel. In the end said shearing of the webs results in the necessary setting force not being exerted during the setting operation and in a corresponding manner an unusable blind rivet connection being realized. Such a problem also exists if there is a non-precise concentric alignment between the rivet mandrel and the gripping jaws. Finally there is also the risk of the rivet mandrel being inserted into the gripping jaws in a non-centered manner as a result of tolerance clearance spaces etc. such that the gripping jaws do not grip the rivet mandrel fully. Three gripping jaws are usually arranged surrounding the rivet mandrel in a ring-shaped manner. Where the rivet mandrel is positioned in a non-centered manner inside an accommodating means which is defined by the gripping jaws, there is the risk of one gripping jaw not engaging. The radial displacement of the gripping jaws to close the gripping jaws is usually effected by means of a wedge-shaped outer structure of the gripping jaws which interacts with a preferably corresponding inclination of a tension sleeve of the setting tool.

In order to avoid such shearing of individual grooves, according to DE 40 03 494 A1 the gripping portion of the rivet mandrel is provided with a conical development in place of a groove structure. In a complementary manner to this, the gripping jaws of the tension head are also realized in a cone-shaped manner. The rivet mandrel is clamped in the region of the cone faces. High tensile forces can be applied in this respect by the expanding, conical development.

The problem of the rivet mandrel being gripped and clamped in a non-centered manner by the gripping jaws also exists here.

Proceeding from this point, the object underlying the invention is to ensure that a process of setting a rivet mandrel is reliable and dependable.

The object is achieved as claimed in the invention by a method for setting a blind rivet by means of a tension head with the features of claim 1, by a blind rivet with the features of claim 6, which is realized in particular for use with a method of this type, as well as finally by a tension head with the features of claim 11.

The advantages and preferred developments referred to below with regard to the individual aspects, that is to say with regard to the method, the blind rivet and the tension head are also transferable in an analogous manner in each case reciprocally to the other aspects.

In the case of the method for setting the blind rivet, a rivet mandrel of the blind rivet is gripped in a gripping portion and pulled in the axial direction by means of a tension head, which has several gripping jaws which are displaceable in the radial direction. In this respect, a tensile force, which is strong enough to deform the blind rivet when it is being set into a pre-drilled component at a defined setting force, is exerted onto the rivet mandrel by means of the tension head. The rivet mandrel is inserted as usual from the front into the tension head with the gripping jaws open when said gripping jaws are therefore arranged in a radial outer position. The gripping jaws, which are arranged at the height of the gripping portion with the rivet mandrel inserted, are then displaced radially in the direction of the rivet mandrel into a closed position. Unlike known concepts, the tension head and the rivet mandrel are matched to one another in such a manner that, in their closed position, the gripping jaws do not clamp the gripping portion, but simply encompass it loosely such that when an axial pulling movement of the tension head is exerted, the gripping jaws initially slide along the gripping portion of the rivet mandrel and only from a following defined tension position transfer the necessary tensile force onto the rivet mandrel for pulling said rivet mandrel and entrain it in the axial direction.

The term “encompass loosely” refers generally in this connection to the fact that the gripping jaws do not clamp the rivet mandrel at least in the region of a front sliding portion of the gripping portion such that it is ensured in all cases that the gripping jaws slide along the gripping portion prior to the start of the actual setting operation when, therefore, the tensile force acting on the rivet mandrel increases, for example for deforming the rivet sleeve. No later than when the tensile force increases during the setting operation, the gripping jaws slide along the gripping portion into the predetermined tension position in which the necessary tensile force is then exerted. The tension head and the rivet mandrel are consequently matched to one another in such a manner that sliding of this type is ensured at every setting operation.

The particular advantage achieved by said measure, among other things, is that if the rivet mandrel is oriented in a non-centered manner with reference to the gripping jaws, all the clamping jaws continue to engage with the rivet mandrel and consequently contribute in a reliable manner to the process of exerting the necessary tensile force.

Over and above this, the rivet mandrel is generally also characterized in the region of the gripping portion by a smooth groove-free surface in order, on the one hand, to enable the sliding and, on the other hand, to avoid the risk of the grooves shearing.

In an expedient further development, the tensile force, which is necessary for the deforming of the blind rivet during the setting operation, is preferably transferred exclusively by positive locking between the gripping jaws and a stop on the end of the gripping portion. Unlike previous systems up to now, there is consequently no provision for the radial clamping of the rivet mandrel. The gripping jaws slide initially in the axial direction in the region of a gliding portion until they abut against the stop which defines the tension position.

In order to ensure that the process of the gripping jaws assuming the predetermined tension position, in particular the stop, is reliable, upstream of said predetermined tension position there is provided—as already mentioned—a sliding portion in which the rivet mandrel is encompassed by the gripping jaws preferably with a radial clearance. In their closed position, the gripping jaws consequently define a closing diameter which has an oversize compared to a gripping diameter of the rivet mandrel in the region of the sliding portion. A small oversize, in this respect, is already sufficient. Thus, the closing diameter corresponds, for example, to the gripping diameter plus a tolerance measurement. An oversize and consequently a radial clearance is preferably set, for example, within the range of between 0.05 mm and 0.2 mm.

In an expedient manner there is an in particular automatic compensating movement between the rivet mandrel and the gripping jaws in the event of a non-centered or non-coaxial alignment between the rivet mandrel and the gripping jaws. There is, therefore, an achievement of symmetry between the gripping partners, which results in a process of transferring the necessary tensile forces being reliable. Thus, for example, the individual gripping jaws are synchronized and/or the rivet mandrel is displaced into the centered position. All in all this ensures that when the tension position has been reached, that is in particular when the stop has been reached, a concentric and as symmetrical as possible an arrangement of the gripping partners, that is of the rivet mandrel and of the gripping jaws, is achieved for reliable gripping.

The achievement of symmetry, in this regard, is also supported by the usually loose bearing arrangement of the individual clamping jaws inside the tension head. Said clamping jaws are mounted in a floating manner inside a tension sleeve. Said loose bearing arrangement consequently also makes possible a compensating movement of the gripping jaws for achieving the symmetrical, concentric arrangement.

The axial extension of the gripping portion is preferably between 1.2 and 1.5 times an axial length of the gripping jaws. On the one hand, this ensures that the process of inserting the gripping jaws into the gripping portion is reliable. On the other hand, as a result a sufficient sliding path is also ensured.

In a corresponding manner, the blind rivet as claimed in the invention has a rivet mandrel with a sliding portion which is realized for sliding the gripping jaws of the tension head in the axial direction. The sliding portion, in this case, is at least part of the gripping portion and extends preferably over the entire length of the gripping portion. The sliding portion, consequently, is adapted overall to an associated tension head such that sliding is made possible with the interaction. In general, in a preferred development the rivet mandrel has a constant cross sectional geometry in the sliding portion in order to make the sliding possible.

In an expedient manner the gripping portion is formed by a cylinder or a cylindrical lateral surface at least in the region of the sliding portion and has there a constant circular cross section with a smooth profile-free and groove-free surface. On the one hand, said development is simple to produce. On the other hand, it also makes it possible to insert the blind rivet into the tension head in an arbitrary position of rotation and no special (rotational) orientation of the rivet in relation to the tension head is necessary.

As already mentioned, the gripping portion is defined at the end by a stop. Said stop is realized in an expedient manner as a (circular) ring face which is oriented at right angles to the axial direction.

In a corresponding manner, outside the gripping portion the rivet mandrel has a mandrel diameter which is greater in the gripping portion compared to a gripping diameter in order to form the stop. The mandrel diameter, in this case, corresponds to between 1.1 and 1.5 times the gripping diameter of the gripping portion. This means that a sufficiently large stop surface is provided.

For realizing the gripping portion, in a first design variant said gripping portion is realized in a tapering manner in relation to the rest of the rivet mandrel and in particular in relation to the mandrel diameter. As an alternative to this, the stop is realized by means of a thickening which only extends, for example, over a region of a portion of the rivet mandrel. The realization of the gripping portion with the associated stop, in this case, is effected by means of a simple rolling method, which can be carried out in a cost-efficient manner and with little expenditure. For production, the rivet mandrel is consequently moved between rotating rollers such that there is material displacement.

In a preferred development, a force absorbing portion of the rivet mandrel, which preferably has the mandrel diameter, connects to the stop in the axial direction. The force absorbing portion, in this case, is designed in such a manner that it is fully able to absorb the tensile force necessary for the setting operation. No force is transferred, at least no noteworthy force is transferred in the region of the sliding portion. The tensile force is transferred exclusively by means of the stop. It is provided in a corresponding manner that the force absorbing portion has a sufficient length extent which is at least 0.5 times and preferably at least between 1 and 1.5 times the rivet mandrel diameter.

In addition, the rivet mandrel usually also has a predetermined breaking point at which it shears once a required breaking force, which corresponds to the setting force, has been reached. This is usually achieved by means of an annular groove. In order to ensure reliable shearing at the required breaking point, the gripping portion, compared to the required breaking point, has greater strength, in particular a larger gripping diameter compared to a required breaking diameter at the required breaking point.

An exemplary embodiment of the invention is explained in more detail below by way of the figures. Said figures, in partially simplified representations, are in each case as follows:

FIG. 1 shows a sectional representation through a tension head with a blind rivet accommodated therein,

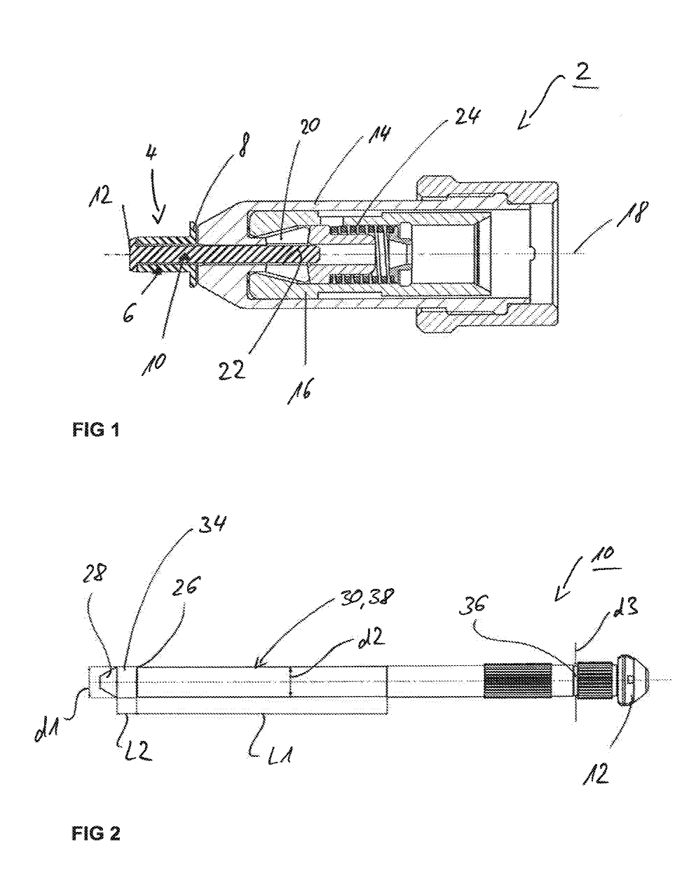

FIG. 2 shows a side view of a rivet mandrel,

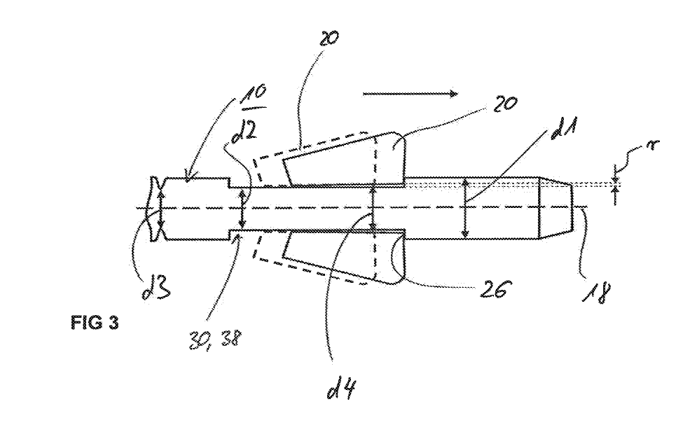

FIG. 3 shows a schematic representation of a detail of the rivet mandrel in the region of a gripping portion together with illustrated clamping jaws of the tension head.

Identically acting parts are provided with the identical references in the figures.

The tension head 2 shown in FIG. 1 is part of a setting tool (not shown here in any detail) which is realized preferably for the automatic setting of blind rivets 4. Such a blind rivet 4 is shown in FIG. 1 as an example. The blind rivet 4 basically has a rivet sleeve 6 with a setting head 8 and a rivet mandrel 10, which is guided right through the rivet sleeve 6 and has a mandrel head 12 which protrudes from the end of the rivet sleeve 6.

The tension head 2 includes a housing 14 in which a tension sleeve 16 is guided in a manner known per se so as to be slidingly movable in the axial direction 18. During the setting operation, the tension sleeve 16 is pulled rearward by way of a drive (not shown in detail here), for example in a displacement-controlled or force-controlled manner. On its front end, the tension sleeve 16 has an inclinedly extending inside wall such that at the front end side a, for instance, conically tapering accommodating space for gripping jaws 20 is formed. Several gripping jaws 20, which, when viewed for instance in cross section, are each wedge-shaped, are usually enclosed in said space loosely distributed around the periphery. The gripping jaws 20, consequently, widen in the axial direction 18. The wedge angle, in this case, is adapted to the angle of the inclined position of the inside wall of the tension sleeve 16 such that the outside wall of the gripping jaws 20 extends in each case approximately parallel to the corresponding inside wall of the tension sleeve 16. The gripping jaws 20, in this case,—when viewed in cross section at right angles to the axial direction—are realized as circular ring segments. A total of three gripping jaws 20 are usually provided distributed about the periphery. Said gripping jaws are spaced apart somewhat from one another in the circumferential direction.

The gripping jaws 20 have toward the center in each case a gripping face 22 which is realized as a segment of the cylindrical face. The gripping faces 22 of the gripping jaws 20 define overall a cylindrical gripping space. The gripping faces 22, in this case, are preferably realized as smooth, flat faces. As an alternative to this, they can also be provided for example—as in the case of conventional gripping tools—with a groove structure.

The gripping jaws 20 are displaceable by means of the tension sleeve 16 in the radial direction from an outer open position to a radially inner closed position. In the open position, they are held by means of a resetting element which is realized as spring element 24 and presses the gripping jaws 20 into an axially front position.

The transferring into the closed position is effected as the tension sleeve 16 is pulled in the axial direction 18. This means that the gripping jaws 20 are displaced inward in the radial direction by their wedge shape on the one hand and by the conical development of the tension sleeve 16 on the other hand.

To set the blind rivet 4, said blind rivet is inserted into at least one pre-drilled component with the mandrel head 12 in front. The tension head 2, in this case, presses the setting head 8 against the surface of the component. The tension sleeve 16 is then pulled rearward in the axial direction 18. The rivet mandrel 10 is entrained at the same time such that the mandrel head 12 is displaced against the rivet sleeve 6, as a result of which the rivet sleeve 6 is deformed and a closing head is formed. The component or components are then clamped between the realized closing head and the setting head 6. A pre-determined defined setting force, which is transferred as tensile force to the rivet sleeve 6 by means of the rivet mandrel 10, is necessary for plastically deforming the rivet sleeve 6.

In order to be able to apply the necessary tensile force, in the case of previous systems the rivet mandrels 10 were provided with grooves in which the gripping jaws 20 engaged by way of a complementary groove structure and gripped the rivet mandrel 10 in a clamping manner.

In contrast, as claimed in the new system described here there is no provision for radial clamping. Rather, the individual components are matched with respect to one another in such a manner that even in the closed position of the gripping jaws 20, said gripping jaws basically, that is during each setting operation, slide along the rivet mandrel 10 as far as up to a stop 26 and only then transfer the tensile force necessary for the deforming operation to the rivet mandrel 10.

A specially realized rivet mandrel 10 is provided for this purpose, as can be found in FIGS. 2 and 3:

The rivet mandrel 10 extends in the axial direction 18 from a mandrel head 12 as far as up to a conical mandrel end 28 located opposite. The rivet mandrel 10 has a gripping portion 30 which extends over a portion length 11 and extends in the axial direction 18 as far as up to the stop 26 which is realized as a ring-shaped stop. A force absorbing portion 34, which has an axial length 12 and then merges into the conical mandrel end 28, connects to the stop 26. In addition, a required breaking point 36 is realized by an annular groove between the gripping portion 30 and the mandrel head 12. In the region of the annular groove, the rivet mandrel 10 has a required breaking diameter d3 which is smaller than the gripping diameter d2. The mandrel has two regions with knurling in the shaft region between the gripping portion 30 and the mandrel head 12.

The rivet mandrel 10 has a mandrel diameter d1 which the rivet mandrel 10 has in the region of the force absorbing portion 34 and in the portion which connects to the gripping portion 30. In the gripping portion 30 itself, the rivet mandrel has a gripping diameter d2 which is smaller than the mandrel diameter d1. The mandrel diameter d1 is typically within the range of a few millimeters, for example within the range of between 2 and 4 mm. Typically, it is between 1.1 and 1.5 times the gripping diameter d2.

In the region of the gripping portion 30, the rivet mandrel 10 has a cylindrical development with a cross sectional area which is constant over the entire portion length 11. As a result, the entire gripping portion 30 is also realized at the same time as sliding portion 38. In the exemplary embodiment the portion length 11 is very long, is a multiple of the mandrel diameter d1 and extends, for instance, over 30% to 50% of the overall length of the rivet mandrel 10.

The functioning and the method of operation of the new concept are explained below by way of FIG. 3. FIG. 3 shows the gripping jaws 20 in their closed position where they are therefore displaced radially in the direction of the center axis. By means of suitable measures on the tension head 2, for example by means of a stop for defining the relative movement of the tension sleeve 16 in relation to the gripping jaws 20, in the closed position the gripping jaws 20 define a fixedly predetermined closing diameter d4 which is at least slightly larger than the gripping diameter d2. The radial displacement path of the gripping jaws is consequently defined in a mechanical manner. Consequently the gripping jaws 20 do not clamp the rivet mandrel 10 in the gripping portion 30, at least not in such a manner that a tensile force can be transferred. As a result of a non-precise concentric arrangement between the rivet mandrel 10 and the gripping jaws 20, they exert a slight clamping at the most. However, the defining of the radial adjustment path of the gripping jaws 20 ensures overall that the gripping jaws 20 are able to slide along the gripping portion 30.

A radial clearance r is realized between the gripping faces 22 of the gripping jaws 30 and the cylindrical lateral surface of the gripping portion 30 as a result of the larger closing diameter d4.

In the starting position, the gripping jaws 20 are initially in a position at a spacing from the stop 26, as is indicated as an example by the gripping jaws 20 shown by the broken line. The gripping jaws together with the tension sleeve 16 are then pulled in the axial direction 18 such that they slide along the sliding portion 38, which at the same time forms the gripping portion 30, until they reach the stop 26. This is the defined tension position from which the rivet mandrel 10 is pulled in the axial direction 18 for exerting the necessary setting force. During said pulling movement, no additional radial force is exerted onto the gripping jaws 20 by the rivet sleeve 6. The entrainment of the rivet mandrel 10 during the operation for deforming the rivet sleeve 6 is effected exclusively by the positive locking between the gripping jaws 20 and the stop 26. A radial engagement is realized for this purpose. The rear contact face of the gripping jaws which is oriented toward the stop 26 is oriented in an expedient manner at least approximately parallel to the stop and consequently in particular at right angles to the axial direction 18.

Once the deforming or setting operation has been carried out, the tensile force typically increases strongly, which leads to the rivet mandrel 10 shearing at the required breaking point 36. The tension sleeve 16 is then relieved again and the residual mandrel still remaining in the tension head 2 is released again by the spring element 24 and can be disposed of. The next blind rivet 4 is then brought into the tension head 2 with the rivet mandrel 10 in front.

In this case the tension head 2 is, in particular, part of a setting tool for the preferably fully automated setting of blind rivets, for example by means of industrial robots, in particular for the production of motor vehicles.

A reliable, in particular automated blind rivet setting process is made possible by means of the blind rivet setting concept described here with the components of the blind rivets 4 matched to one another, with the specially realized sliding portion 38 and the tension head 2 realized in a corresponding manner thereto and with the in particular mechanical defining of the closing diameter d4 to a fixed predetermined value.

Neither do problems occur as a result of the shearing of groove structures as these have preferably been completely dispensed with both on the part of the rivet mandrel 10 and on the part of the gripping jaws 20. Over and above this, as a result of making sliding possible during the pulling operation, symmetry between gripping partners, that is of the gripping portion 30 in relation to the gripping jaws 20, is achieved automatically such that overall the tensile force is transferred coaxially and symmetrically onto the rivet mandrel 10 by means of the stop 26.

As a result of the sliding path of the gripping jaws 20 and their floating bearing arrangement in the rivet sleeve 6, the gripping jaws are able to carry out a certain compensating movement. As an alternative to this or in addition to it, the rivet mandrel can also carry out a compensating movement of this type. In particular, in this respect the radial clearance r also allows for a certain tipping movement of the rivet mandrel 10 in the closed position of the gripping jaws 20 such that a coaxial, concentric alignment between the gripping jaws 20 and the rivet mandrel 10 is made possible.

List of References

| | |
|---|---|
| 2 | Tension head |
| 4 | Blind rivet |
| 6 | Rivet sleeve |
| 8 | Setting head |
| 10 | Rivet mandrel |
| 12 | Mandrel head |
| 14 | Housing |
| 16 | Tension sleeve |
| 18 | Axial direction |
| 20 | Gripping jaws |
| 22 | Gripping face |
| 24 | Spring element |
| 26 | Stop |
| 28 | Mandrel end |
| 30 | Gripping portion |
| 26 | Stop |
| 34 | Force absorbing portion |
| 36 | Required breaking point |
| 38 | Sliding portion |
| d1 | Mandrel diameter |
| d2 | Gripping diameter |
| d3 | Required breaking diameter |
| d4 | Closing diameter |
| 11 | Portion length |
| 12 | Length of the force absorbing portion |
| r | Radial clearance |

1-13. (canceled)

14. A method of setting a blind rivet by way of a tension head, the blind rivet extending in an axial direction and having a rivet sleeve and a rivet mandrel with a gripping portion, and the tension head including gripping jaws for gripping and for axially pulling the rivet mandrel, the method which comprises:
inserting the rivet mandrel into the tension head with the gripping jaws of the tension head open;
radially displacing the gripping jaws in a direction of the rivet mandrel into a closed position in a region of the gripping portion of the rivet mandrel;
gripping the rivet mandrel with the gripping jaws in the closed position and pulling the rivet mandrel in the axial direction, wherein the tension head and the rivet mandrel are matched to one another such that in the closed position the gripping jaws initially slide along the gripping portion of the rivet mandrel and only from a predetermined tension position transfer a necessary tensile force onto the rivet mandrel for pulling said rivet mandrel.

15. The method according to claim 14, wherein the gripping portion is restricted in the axial direction by a stop which defines the tension position, and the tensile force is transferred exclusively by way of a positive lock between the stop and the gripping jaws.

16. The method according to claim 14, wherein the gripping portion has a sliding portion in which the rivet mandrel is encompassed by the gripping jaws with radial clearance.

17. The method according to claim 14, wherein the gripping portion has a circular cross sectional area with a constant gripping diameter over entire axial length thereof.

18. The method according to claim 14, which comprises, when the gripping jaws slide along the gripping portion, effecting an automatic compensating movement between the rivet mandrel and the gripping jaws.

19. A blind rivet for the method according to claim 14, the blind rivet comprising a rivet sleeve and a rivet mandrel extending in the axial direction and being formed with a gripping portion, said gripping portion having a sliding portion configured for sliding the gripping jaws of a tension head in the axial direction.

20. The blind rivet according to claim 19, wherein said gripping portion has a cross sectional area that remains constant in the axial direction.

21. The blind rivet according to claim 20, wherein said gripping portion has a circular cross section that remains constant in the axial direction.

22. The blind rivet according to claim 19, which comprises a stop delimiting said gripping portion in the axial direction, said stop being configured for absorbing a tensile force that is necessary for setting the blind rivet.

23. The blind rivet according to claim 19, wherein said rivet mandrel has a given mandrel diameter and said gripping portion has a given gripping diameter that is smaller than the given mandrel diameter.

24. The blind rivet according to claim 23, wherein said given mandrel diameter is greater than said given gripping diameter of said gripping portion at least by a factor of between 1.1 and 1.5.

25. The blind rivet according to claim 23, wherein a force absorbing portion with a mandrel diameter that is enlarged relative to said gripping portion connects to said stop in the axial direction, and wherein a length of the force absorbing portion corresponds to at least 0.5 times the mandrel diameter.

26. The blind rivet according to claim 25, wherein the length of the force absorbing portion corresponds to between 1 and 1.5 times the mandrel diameter.

27. A tension head configured for accommodating the blind rivet according to claim 19.

28. The tension head according to claim 27, which comprises gripping jaws that are displaceable in a radial direction between an open position and a closed position, wherein in the closed position said gripping jaws define a closed diameter that is greater than a gripping diameter of the rivet mandrel in a gripping portion thereof.
